(19) United States
(12) Patent Application Publication
(10) Pub. No.: US 2012/0285277 A1
(43) Pub. Date: Nov. 15, 2012

(54) MECHANICAL TOOTHBRUSH

(76) Inventor: Jeong-Pyo Kim, Incheon (KR)

(21) Appl. No.: 13/574,284

(22) PCT Filed: Jan. 17, 2011
(86) PCT No.: PCT/KR2011/000337

§ 371 Date: Jul. 20, 2012

(30) Foreign Application Priority Data
Jan. 22, 2010 (KR) 10-2010-0005796
Jan. 17, 2011 (KR) PCT/KR2011/000337

(51) Int. Cl. F16H 19/04

(52) U.S. Cl. 74/31

(57) ABSTRACT

The present invention relates to brushing the teeth, and more particularly, to a method for moving a toothbrush in a top down manner for the upper teeth and in a bottom up manner for the lower teeth. For this purpose, the mechanical toothbrush of the present invention is configured such that a handle of the toothbrush is closed/opened similar to one exercising with a hand gripper (an exercise tool for increasing grip strength), so as to convert the linear motion of a rack gear into a rotating motion, and thus enable the toothbrush to rotate from 0 to 180 degrees, and the rotating direction of the toothbrush can be changed using the rack gear and a rotation-converting frame. A tension spring is connected to a rotating shaft such that a toothed wheel of the rotating shaft is prevented from escaping from the rack gear, and the rotating shaft is fixed at the rotation-converting frame. The handle and the rack gear return to the original positions thereof by means of the elasticity of a torsion spring. A toothbrush-fixing frame enables the toothbrush to be conveniently replaced, and supports the toothbrush such that the toothbrush does not vibrate.

### TECHNICAL FIELD

The present invention relates to a tooth bushing, and in particular to a method which helps brush teeth in such a way that a toothbrush brushes upper teeth from upper side to lower side and brushes lower teeth from down side to upper side.

### BACKGROUND ART

Dental hospitals recommend brushing upper teeth from upper side to lower side and brushing lower teeth from lower side to upper side for the purpose of making teeth healthy when brushing teeth; however it is not easy to brush teeth in the above mentioned manner. Most of people are accustomed to brush teeth in a leftward and rightward linear direction, so the above-mentioned method is hard to get accustomed.

### DISCLOSURE OF INVENTION

Accordingly, it is an object of the present invention to provide a mechanical toothbrush which helps easily remove food debris caught between teeth in such a way to move a toothbrush from upper side to lower side for upper teeth and to move from lower side to upper side for lower teeth when brushing teeth, and it is easy to get accustomed to a method that a brush moves upward and downward.

The present invention is characterized in that a toothbrush is constructed to rotate from 0° to 180° as a user moves a toothbrush like when a user grips and releases handgrips (an exercise tool helping improve the gripping force of hands). When the toothbrush 7 is positioned at a root portion of each tooth and is forced to rotate, the toothbrush 7 brushes along between teeth like a broom brushes. So, the above mentioned operation has effects like a motion that the toothbrush 7 brushes from upper side to lower side and from lower side to upper side. When a user grips the handles 1 of both sides, the linear motion of the rack gear 10 is changed to a rotational motion, thus rotating the toothbrush 7. When the user releases the gripped handles 1 of both sides, it returns to the original state with the aid of the elastic force of a torsion spring 9. As the rack gear 10 is installed at both sides, and the rotary shaft 3 fixed at a rotation conversion frame 11 is moved in the direction of an arrow of FIG. 11 with the aid of hands and is fixed at a left side or a right side for thereby changing the direction of rotation. When the rotary shaft 3 is fixed at the left side, the toothed gear 4 is engaged with the left side rack gear 10, so the toothbrush 7 rotates leftward, and when the rotary shaft 3 is fixed at the right side, the toothed gear 4 is engaged with the right side rack gear 10, so the toothbrush 7 rotates rightward. At this time, a tension spring 2 caught by the rotary shaft3 helps fix the rotary shaft 3 at the rotation conversion frame 11 so that it does not escape from the rack gear 10 when the toothed gear 4 rotates. The engaging shoulder 12 helps prevent the handles 1 of both sides from being widened more.

### ADVANTAGEOUS EFFECTS

The present invention has advantages that when a user brushes teeth, the upper teeth are brushed from upper side to lower side, and the lower teeth are brushed from lower side to upper side for thereby easily removing food debris from between teeth, and the user can easily get accustomed to a method of brushing a toothbrush from upper side to lower side and from lower side to upper side.

### BRIEF DESCRIPTION OF DRAWINGS

FIG. 1 is a plane view.

FIG. 2 is a rear view.

FIG. 3 is a side view.

FIG. 4 is a perspective view.

FIG. 5 is an enlarged right side view.

FIG. 6 is an enlarged perspective view when viewing from an inner side a state that a toothed gear of a rotary shaft is engaged with a rack gear.

FIG. 7 is an enlarged perspective view when viewing from an inner side a state that a rack gear has moved when a user grips both handles of both sides.

FIG. 8 is a view of parts used in the present invention.

FIG. 9 is a view illustrating the position of a rotary shaft.

FIG. 10 is a view illustrating the position of a torsion spring.

FIG. 11 is an enlarged view illustrating a rotation conversion frame in which the movement of a rotary shaft is indicated by the arrow.

### MODES FOR CARRYING OUT THE INVENTION

The present invention will be described with reference to the accompanying drawings.

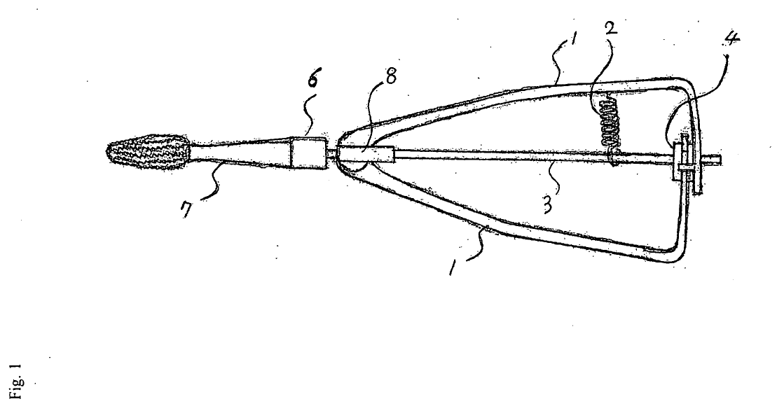

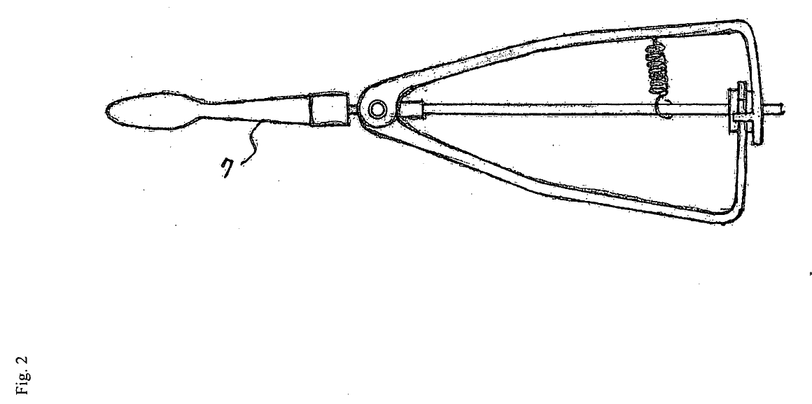

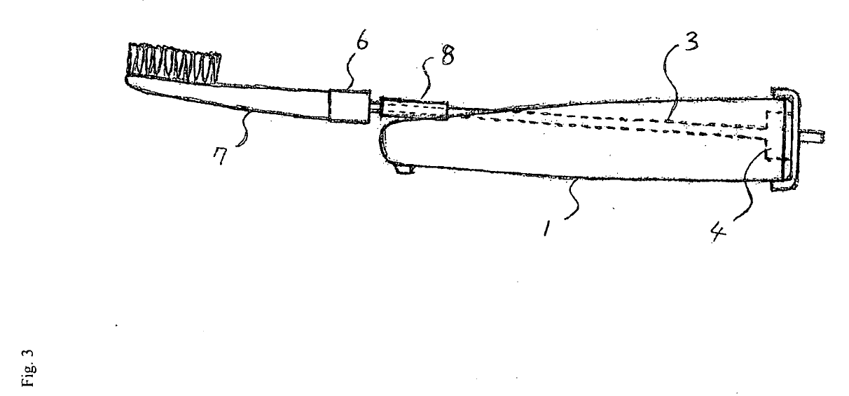

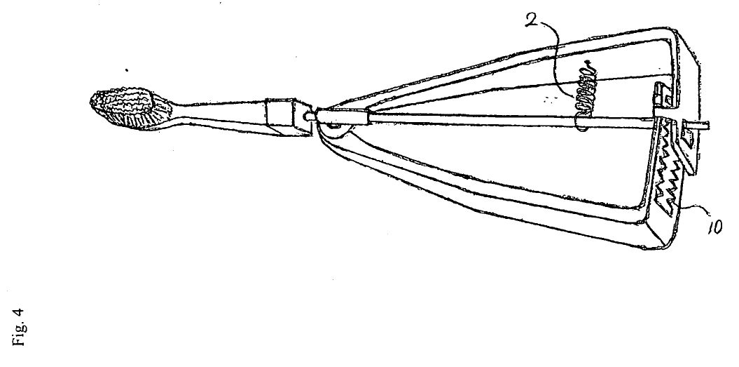

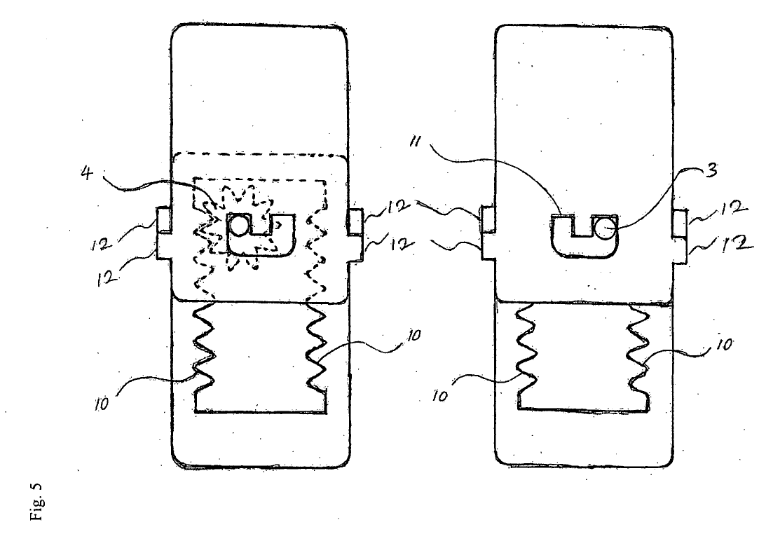

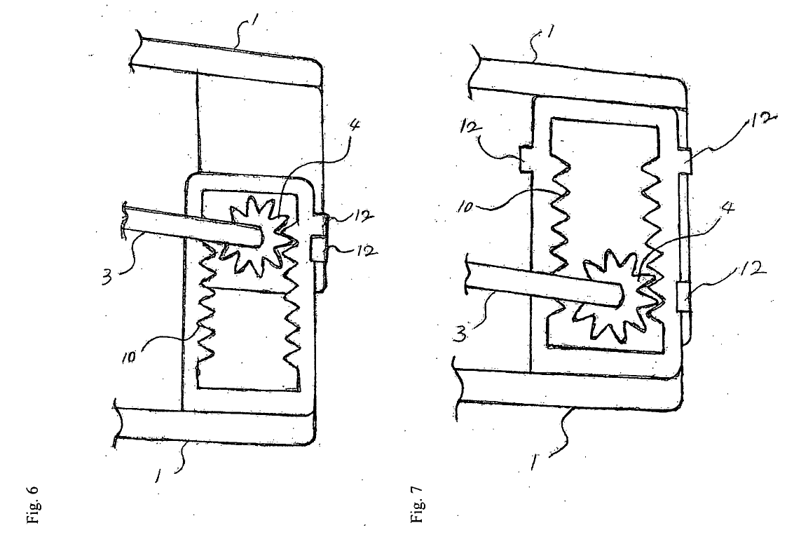

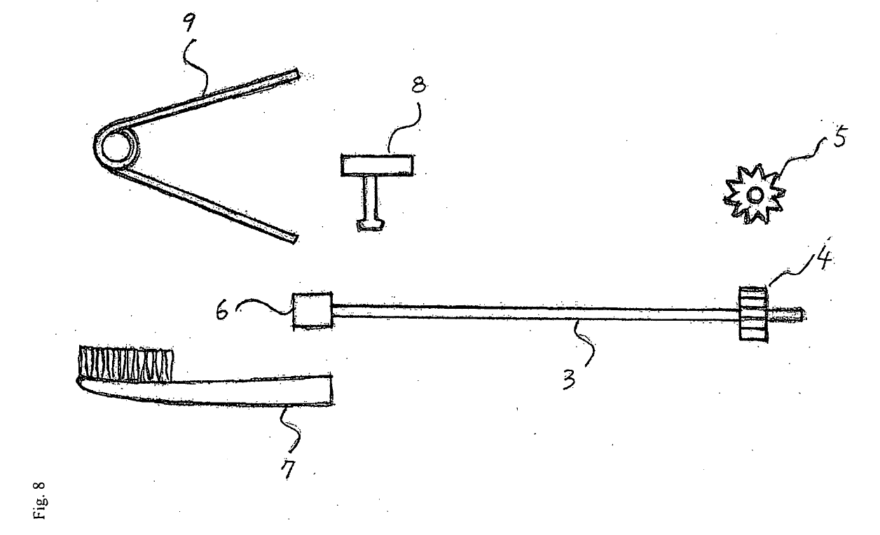

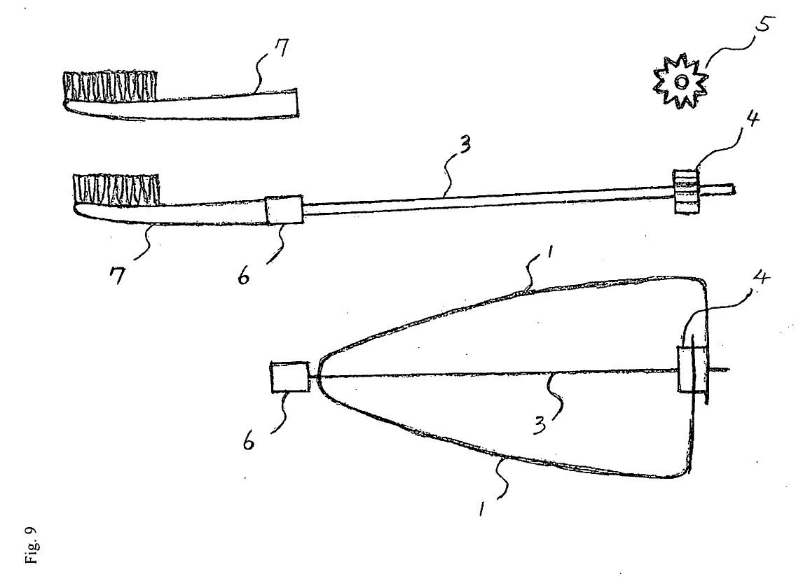

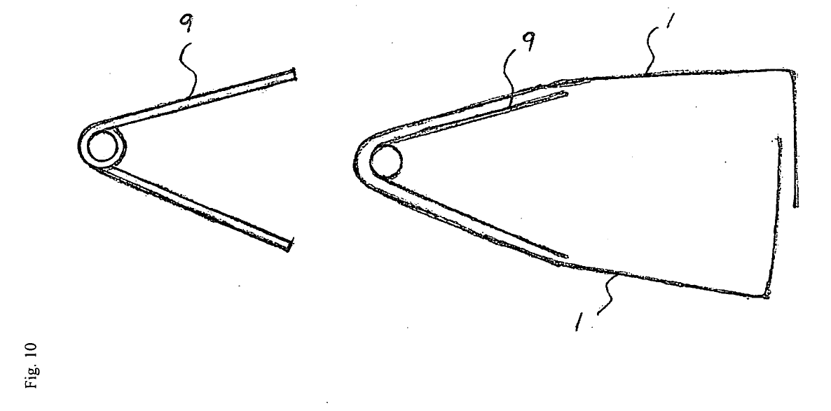

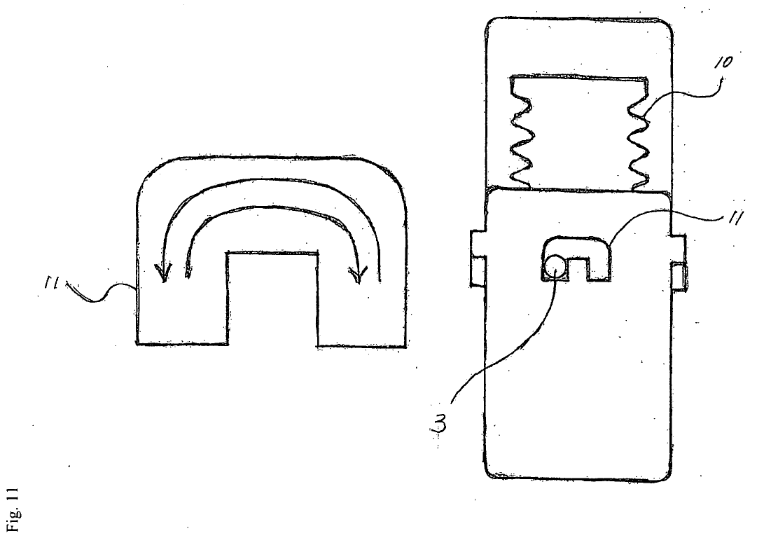

As shown in FIG. 1, the handle 1 is provided at both sides like handgrips (an exercise tool helping improve the gripping force of hands), and a tension spring 2 is caught by a rotary shaft 3. The tension spring 2 has an elastic force strong enough not to affect the rotation of the rotary shaft 3 and is fixed at a rotation conversion frame 11 so that the toothed gear 4 of the rotary shaft 3 does not escape from the rack gear 10. FIG. 8 is a view illustrating the rotary shaft 3, the toothed pat 4, the cross section 5 of the toothed gear, the toothbrush fixing frame 6, the toothbrush 7, the rotary shaft fixing frame 8 and the torsion spring 9. FIG. 9 is a view of the position of the rotary shaft 3. FIG. 10 is a view of the position of the torsion spring 9. FIG. 5 is a view illustrating a construction that the toothed gear 4 of the rotary shaft 3 is engaged to the rack gear 10, and the rotary shaft 3 is fixed at the rotation conversion frame 11. In a state of FIG. 1, when a user grips both handles 1 of both sides, the rack gear 10 moves linearly and the toothed gear 4 of rotary shaft 3 rotates from 0° to 180°. The rotational force of the toothed gear 4 is transferred to the rotary shaft 3, so the toothbrush 7 fixed at the rotary shaft 3 can rotate from 0° to 180°. When a user releases the gripped handles 1 of both sides, it returns to the original position with the aid of the elastic force of the torsion spring 9. When brushing teeth, the toothbrush 7 is positioned at the root portions of teeth and the handles 1 of both sides are gripped and released like performing an exercise using the handgrips (an exercise tool helping improve the gripping force of hands), during which the toothbrush 7 brushes between teeth like a broom brushes. FIG. 6 is a view illustrating a state that force is not applied, and FIG. 7 is a view illustrating a state that the rack gear 10 has moved when the handles 1 of both sides are gripped. When the gripped handles 1 of both sides are released, it returns to the state of FIG. 6. The toothbrush 7 rotates at bigger angles when gripping more, and rotates at smaller angles when griping less. So, the rotation can be freely adjusted depending on the states of the teeth. FIG. 11 is an enlarged view illustrating the rotation conversion frame 11, and the rotary shaft 3 can move to here and there using the hands as indicated by the arrow. In more details, when the rotary shaft 3 is positioned at the right side, the toothbrush 7 rotates rightward, and when the rotary shaft 3 is positioned at the left side, the toothbrush 7 rotates leftward. The engaging shoulder 12 serves to help prevent the handles 1 of both sides from being widened more. Others tools might be fixed at the toothbrush fixing frame 6 for another purpose of universal uses.

1. A mechanical toothbrush, comprising:
a pair of L-shaped handles 1 of one of which is formed at a bottom portion in such a way that a groove-shaped rack gear 10 face from both sides of a groove, and the other of which forms a lying down U-shaped groove-like rotation conversion frame 11 at the bottom portion, the handles 1 of both sides and the torsion spring 9 are engaged at the bolt portion of the rotary shaft fixing frame 8, and the rotary shaft 3 passes through the upper tube portion of the rotary shaft fixing frame 8, and when a user grips the handles 1 of both sides, the linear motion of the rack gear 10 is converted into a rotational motion, thus rotating the toothbrush 7, and when the gripped handles 1 of both sides are released, it returns to the original state with the aid of the elastic force of the torsion spring 9, and the rotation direction can be changed using the rotation conversion frame 11, and the tension spring 2 is caught by the rotary shaft 3 and is fixed and the rotary shaft 3 is fixed at the rotation conversion frame 11 so that the toothed gear 4 of the rotary shaft 3 does not escape from the rack gear 10, and an engaging shoulder 12 is provided for the purpose of preventing the handles 1 of both sides from being widened more, and the rotary shaft 3 passes through the rack gear 10, and the toothed gear 4 is engaged with the rack gear 10, and when the rotary shaft 3 is moved from the lying down U-shaped groove-like rotation conversion frame 11 in the shape of a lying down U-shape, the toothed gear 4 is engaged with the opposite rack gear 10.
